(19) United States
(12) Patent Application Publication
(10) Pub. No.: US 2025/0085097 A1
(43) Pub. Date: Mar. 13, 2025

(54) Wear Sensor

(71) Applicant: K F Group Pty Ltd of Level 1, East Perth (AU)

(72) Inventor: Con Kamaras, East Perth (AU)

(21) Appl. No.: 18/720,563

(22) PCT Filed: Dec. 14, 2022
(86) PCT No.: PCT/AU2022/051509

§ 371 Date: Jun. 14, 2024

(30) Foreign Application Priority Data
Dec. 15, 2021 (AU) 2021904076

(51) Int. Cl. G01B 7/06

(52) U.S. Cl. CPC G01B 7/06

(57) ABSTRACT

A wear sensor (10) comprising a body (12) formed from a planar sheet of flexible material including a plurality arms (14) being integrally formed with the body (12) such that the arms (12) are located coplanar with the body (12). A plurality of conductors are provided extending from the body (12) out along each of the arms (14). The arms (14) are bendable from the coplanar position to an extended position, in which at least a portion of the arms (14) extends perpendicular to the plane of the body (12) to be received within a component such that as the component wears, distal ends (34) of the arms are worn down which can be detected by passing electrical signals through the conductors.

### FIELD OF THE INVENTION

The present invention relates to a sensor for detecting wear in industrial parts and a system incorporating a plurality of such sensors.

### BACKGROUND TO THE INVENTION

Monitoring wear in industrial components is significant both in terms of preventing failures in the equipment and scheduling appropriate maintenance in a way that reduces downtime costs. One particular example is monitoring the wearing of wear plates used to line transfer chutes in conveyor systems. The transfer chutes are lined with plates which will wear over time and eventually need to be replaced. Given the significant expense of shutdowns of such large systems, it is particularly important to ensure that the wearing parts are replaced before the wear becomes too great but not any more often than is necessary.

Present systems utilise sensors positioned on the wearing components to detect wear, such as ultrasonic sensors. Known types of such sensors are often relatively expensive however and there are therefore limits on the number that can be applied in a cost effective manner. Using a larger number of sensors however can provide greater data regarding wear patterns which can enhance analysis in a way which can lead to significant operational cost savings.

The present invention relates to a wear sensor designed such that it is effective in operation and easy to utilise in a variety of locations. It is also relatively simple to construct and therefore more cost effective to produce in larger quantities.

### SUMMARY OF THE INVENTION

According to one aspect of the present invention there is provided a wear sensor comprising:
a body formed from a planar sheet of flexible material;
a plurality arms being integrally formed with the body such that the arms are located coplanar with the body; and
a plurality of conductors extending from the body out along each of the arms;
wherein the arms are bendable from the coplanar position to an extended position, in which at least a portion of the arms extend perpendicular to the plane of the body to be received within a component such that as the component wears, distal ends of the arms are worn down which can be detected by passing electrical signals along the conductors.

Preferably each arm includes a plurality of conductors extending to different positions along the length of the arm such that, as the arm wears, the conductors will be successively damaged from the distal end to the proximal end.

Preferably the conductors comprise conductive tracks printed on the surface of the body and the arms.

Preferably the arms include a plurality of arms formed extending from a peripheral edge of the body such that the arms are each located parallel to an adjacent portion of the edge of the body.

Preferably proximal portions of the arms bendable to be perpendicular to the adjacent portion of the edge of the body but coplanar with the body and distal portions of the arms are bendable to be perpendicular to the plane of the body.

Preferably first bends are provided on the arms around a line perpendicular to the longitudinal axis of the arm to form the transverse distal portion of the arms and second bends are provided closer to the body being around a line at 45 degrees to the longitudinal axis of the arm to form the outwardly extending proximal portions.

In a preferred embodiment, the body comprises a planar frame formed by a plurality of connected elongate frame portions defining a plurality of openings within the body.

Preferably the elongate portions are linear.

Preferably the tracks are provided on some of the elongate frame portions and other elongate frame portions do not include tracks and are provided to support the planar frame structure of the body.

Preferably the conductors from each arm are connected to a junction provided on the body, the junction providing for connection to a sensor control unit.

### BRIEF DESCRIPTION OF THE DRAWINGS

The invention will now be described, by way of example, with reference to the following drawings, in which:

FIG. 1 is top view of a wear sensor in accordance with the present invention;

FIG. 2 is an upper perspective view of the wear sensor of FIG. 1 with arms in extended positions;

FIG. 3 is a view of a wear plate having holes provided for receiving the wear sensor;

FIG. 4 is a view of the wear sensor installed on the plate;

FIG. 5 is top view of a second embodiment of a wear sensor in accordance with the present invention;

FIG. 6 is a view of an alternative construction of a wear plate to which the wear sensor is connected;

FIG. 7a is a partial view of a pipe having a curved wear plate to which the wear sensor of the present invention may be attached;

FIG. 7b is a view of the curved wear plate of FIG. 7a with the wear sensor attached; and

FIG. 7c is a transparent view of the curved wear plate of FIG. 7a showing the position of the installed wear sensor.

### DETAILED DESCRIPTION OF PREFERRED EMBODIMENTS

Referring to the Figures, there is shown a wear sensor 10 comprising generally a planar body 12 having a plurality of elongate arms 14.

The body 12 comprises a flexible planar sheet of material and the arms 14 are formed integrally with the body 12. In the embodiment shown, the body is generally rectangular and therefore has first and second opposed sides 16 and 17 and first and second opposed ends 18 and 19. It will be appreciated however that alternative shapes for the body 12 of the wear sensor 10 may be used.

In the embodiment shown, the body 12 comprises a planar frame formed by a plurality of connected elongate frame portions 13. The elongate frame portions 13 of the frame define a plurality of openings 15 within the body. In the embodiment shown, the elongate portions 15 are all linear, however it will be appreciated that other shapes would be possible. It will also be appreciated that while the body 12 shown comprises a planar frame defined by elongate frame portions 13, the body 12 may also be provided as a solid sheet of material. In either case, the body 12 is formed from a sheet material having the ability to flex and to bend.

The body 12 is formed from a material on which a plurality of conductors may be provided. The conductors comprise conductive tracks 22 printed onto a surface of the body 12. In the embodiment shown, the tracks 22 are provided on some of the elongate frame portions 13, while other elongate frame portions 13 do not include tracks and are provided to support the planar frame structure of the body 12.

Each of the arms 14 comprises a relatively thin elongate member formed during construction of the wear sensor 10 such that the arms 14 are each coplanar with the body 12. In the embodiment shown, a plurality of arms 14 are provided around a peripheral edge 20 of the body 12. Each of the arms 14 provided around the edge 20 are generally parallel to the adjacent portion of the edge 20. Further, one or more arms 14 may be provided centrally within the body 12 extending within one of the openings 15 formed by the frame portions 13.

In the embodiment shown, there are provided three arms 14 along each of the first and second sides 16 and 17 and further arms 14 provided centrally on each of the first and second ends 18 and 19. A single further arm 14 is provided extending centrally from the body 12 within one of the openings. It will be appreciated however that the number and positions of the arms 14 may be varied.

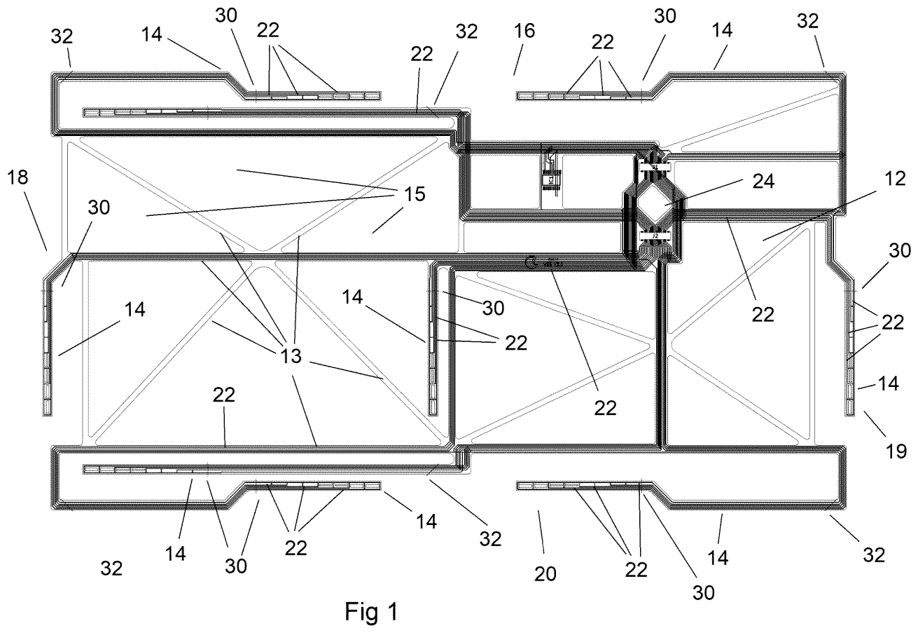

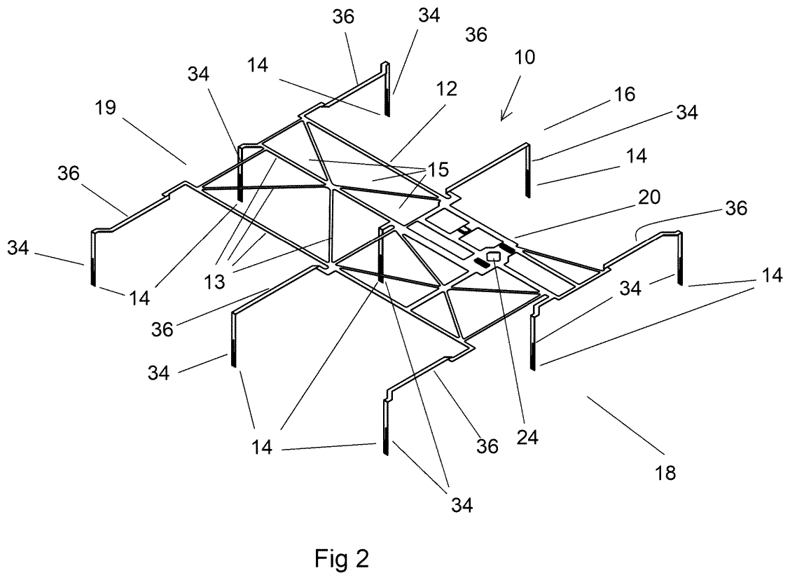

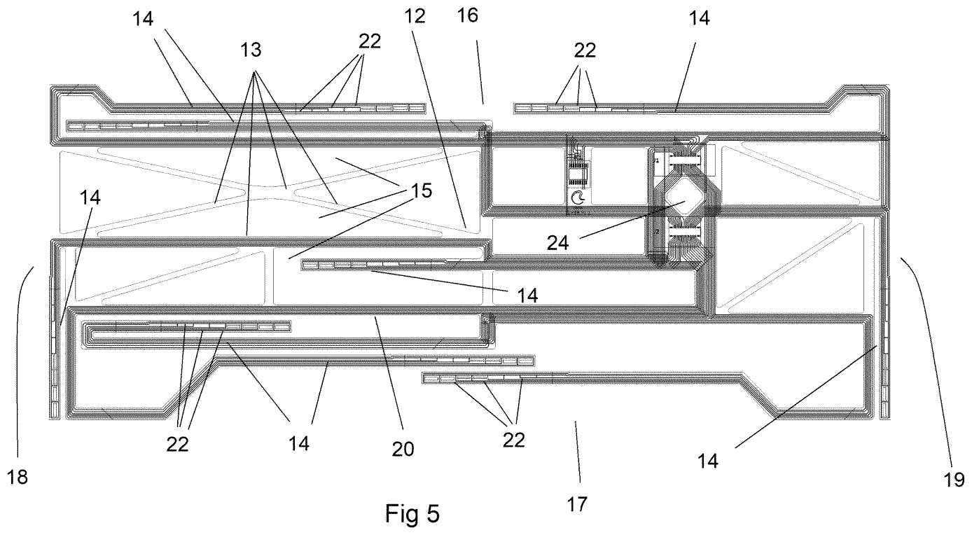

The material from which the body 12 and the arms 14 are formed allows the arms 14 to flex and to also be bent. The arms 14 may be bent such that distal portions 34 thereof are generally perpendicular to the plane of the body 12 by providing first bends 30 on the arms 14 around a line perpendicular to the longitudinal axis of the arm 14. The arms 14 may also be bent such that proximal portions 36 thereof are coplanar with the body 12 but extend transversely to the adjacent edge 20 of the body 12 and the distal portions 34 extend transversely to the plane of the body 12. The arms 14 in this case are provided with a first bend 30 around a line perpendicular to the longitudinal axis of the arm 14 to define the transverse distal portion 34 and a second bend 32 closer to the body 12 being around a line at 45 degrees to the longitudinal axis of the arm 14 to form the outwardly extending proximal portion 36. This arrangement allows the distal ends 34 of the arms 14 to extend further away from the body 12 but minimizes the area of the wear sensor 10 at construction. In the embodiments shown in FIGS. 1 and 5, the arms 14 along the sides 16 and 17 are provided with both first and second bends 30 and 32 while the arms 14 at the ends 18 and 19 and centrally within the body 12 are provided only with the first bends 30.

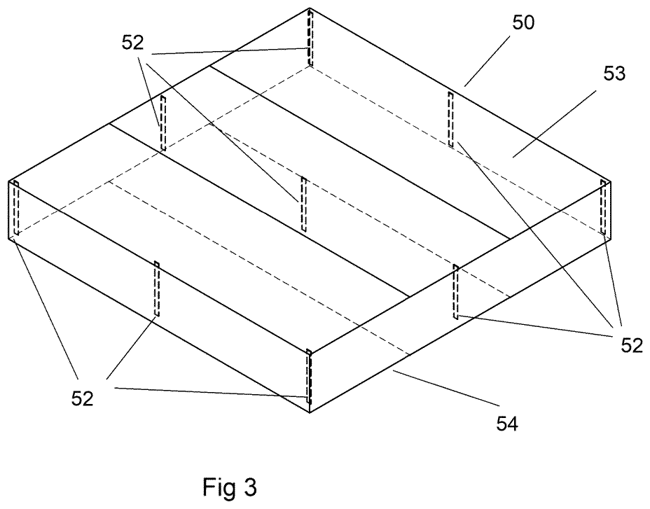

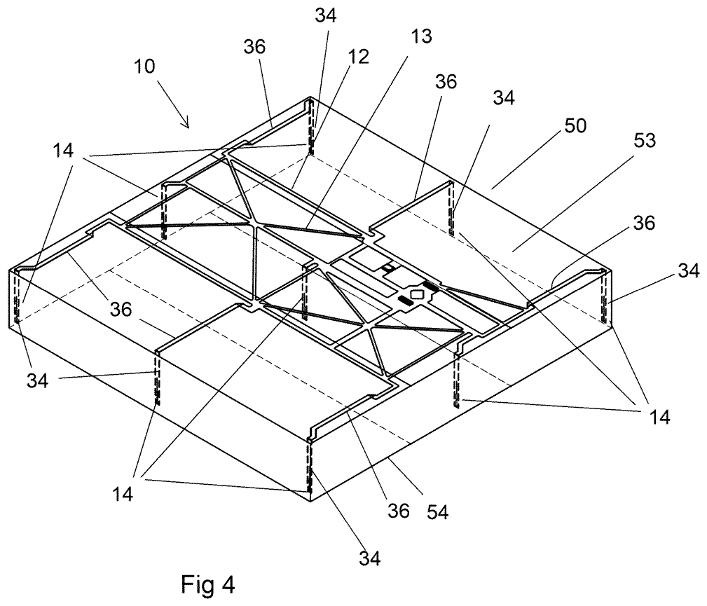

The wear sensor 10 is provided to be fixed relative to a component which is subject to wear in use. In the embodiment shown in FIGS. 3 and 4, the wear sensor 10 is secured to a solid planar wear plate 50. It will be appreciated however that the wear sensor 10 may be used on other components to detect changes in thickness due to wear. For example, the wear sensor 10 may be secured to conveyor pulleys, conveyor scrapers, conveyor belt, pump casings, cast housings, pipe and pipe sections (elbows, reducers, tee's), gyratory crushers, jaw crushers, cone crushers, ball mills, sag mills, dust extraction systems, transfer chutes, hoppers, launders, cyclones or vibrating screens.

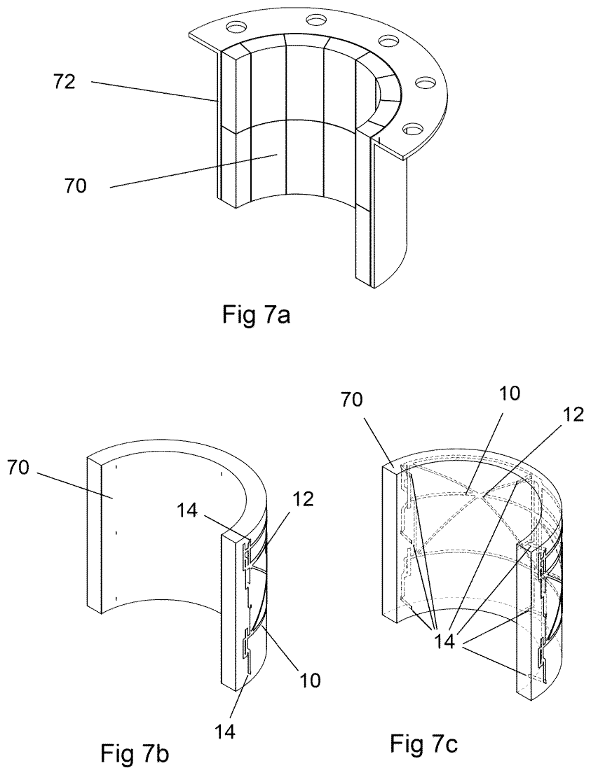

Due to the flexible nature of body 12, the wear sensor 10 may be easily fixed to curved surfaces of such wearing components, such as the surfaces of pipes or other curved wearing components, to detect wear in these components. FIG. 7 shows an example in which the wear sensor 10 is fixed to a curved wear plate 70 provided on an inner surface of a pipe 72. As can be seen in the Figure, the body 12 of the wear sensor 10 can be curved to fit to an outer surface of the wear plate 70.

The plate 50 in the embodiment shown is provided with a plurality of holes 52 extending from a rear surface 53 towards a front surface 54. Each of the holes 52 is positioned to receive the distal portion 34 of one of the arms 14 when the body 12 is secured to the rear surface 53 of the plate 50.

Each of the arms 14 includes a plurality of conductive tracks 22 extending from the body 12 along the arm 14. Each of the tracks 22 on each one of the arms 14 extends to different position along the length of the arm 14. Each of the tracks 22 in the embodiment shown comprises a loop out along the length of the arm 14.

As the conductive tracks 22 on each arm 14 extend to different lengths along the arm 14, as the front surface 54 of the plate 50 wears, the distal ends of the arm 14 will wear and thereby successively break the tracks 22 from the distal end towards the proximal end. By sending signals along the tracks 22 of each arm 14, it is possible to determine which tracks have been damaged and which have not, and thereby determine the thickness of the plate 11 at the location of the arm 14.

The tracks 22 of each arm 14 are connected to a junction 24 on the body 12. The junction 24 is provided to allow connection of the tracks 22 to a sensor control unit. The sensor control unit is provided to send electrical signals on the tracks 22 to determine which tracks 22 on each arm 14 have been damaged and thereby determine the thickness of the plate 50 at the location of each arm 14.

The junction 24 may be connected to a housing (not shown) having a transceiver to send information to and receive information from a remote device. The information may be transmitted wirelessly across a suitable network, such as the Internet.

It is noted that while the arms 14 are shown installed into holes drilled into the component, the wear sensor 10 could be moulded into the body of the wear component during construction of the component. Alternatively, the arms 14 may extend down outer edges of the wear component, such as down between edges of a pair of adjacent wear plates 11.

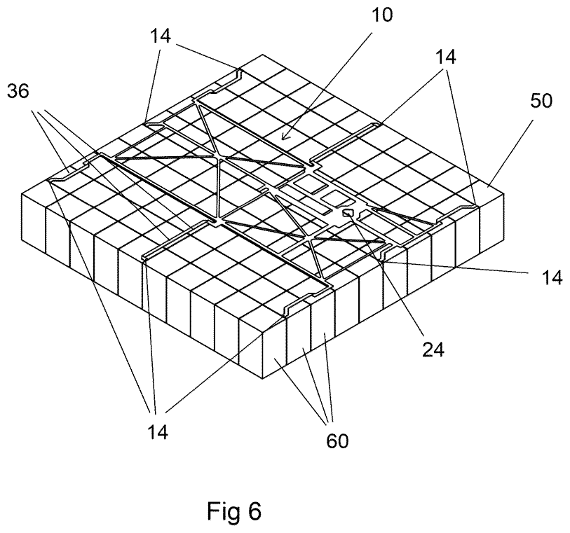

In another embodiment (as can be seen in FIG. 6), a wear plate 50 is formed from a plurality of individual tiles 60. The tiles 60 are bonded together to form the wear plate 50 by a suitable process, such as fixing the tiles together with vulcanized rubber by a heating process. The arms 14 of the wear sensor 10 are inserted between the tiles 60 when the wear plate 50 is formed. The body 12 of the wear sensor 10 is constructed from a material with sufficient resistance to heating to allow the wear sensor to be inserted in place during the process of constructing the bonded wear plate 50.

It will be readily apparent to persons skilled in the relevant arts that various modifications and improvements may be made to the foregoing embodiments, in addition to those already described, without departing from the basic inventive concepts of the present invention.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. A wear sensor comprising:
a body formed from a planar sheet of flexible material;
a plurality arms being integrally formed with the body such that the arms are located coplanar with the body; and
a plurality of conductors extending from the body out along each of the arms;
wherein the arms are bendable from the coplanar position to an extended position, in which at least a portion of the arms extend perpendicular to the plane of the body to be received within a component such that as the component wears, distal ends of the arms are worn down which can be detected by passing electrical signals along the conductors.

12. The wear sensor in accordance with claim 11, wherein each arm includes a plurality of conductors extending to different positions along the length of the arm such that, as the arm wears, the conductors will be successively damaged from the distal end to the proximal end.

13. The wear sensor in accordance with claim 12, wherein the conductors comprise conductive tracks printed on the surface of the body and the arms.

14. The wear sensor in accordance with claim 11, wherein the arms include a plurality of arms formed extending from a peripheral edge of the body such that the arms are each located parallel to an adjacent portion of the edge of the body.

15. The wear sensor in accordance with claim 14, wherein proximal portions of the arms bendable to be perpendicular to the adjacent portion of the edge of the body but coplanar with the body and distal portions of the arms are bendable to be perpendicular to the plane of the body.

16. The wear sensor in accordance with claim 15, wherein first bends are provided on the arms around a line perpendicular to the longitudinal axis of the arm to form the transverse distal portion of the arms and second bends are provided closer to the body being around a line at 45 degrees to the longitudinal axis of the arm to form the outwardly extending proximal portions.

17. The wear sensor in accordance with claim 11, wherein the body comprises a planar frame formed by a plurality of connected elongate frame portions defining a plurality of openings within the body.

18. The wear sensor in accordance with claim 17, wherein the elongate portions are linear.

19. The wear sensor in accordance with claim 17, wherein the tracks are provided on some of the elongate frame portions and other elongate frame portions do not include tracks and are provided to support the planar frame structure of the body.

20. The wear sensor in accordance with claim 11, wherein the conductors from each arm are connected to a junction provided on the body, the junction providing for connection to a sensor control unit.
